(19) United States
(12) Patent Application Publication
(10) Pub. No.: US 2017/0277480 A1
(43) Pub. Date: Sep. 28, 2017

(54) STORAGE MEDIUM, IMAGE FORMING APPARATUS, AND IMAGE FORMING SYSTEM

(71) Applicant: KYOCERA Document Solutions Inc., Osaka (JP)

(72) Inventors: Cedric SARIGUMBA, Osaka-shi (JP); Maria Luisa EXALTACION, Osaka-shi (JP)

(73) Assignee: KYOCERA Document Solutions Inc., Osaka (JP)

(21) Appl. No.: 15/084,111

(22) Filed: Mar. 29, 2016

(30) Foreign Application Priority Data
Mar. 23, 2016 (JP) 2016-58269

(51) Int. Cl. G06F 3/12

(52) U.S. Cl. CPC G06F 3/126; G06F 3/1203

(57) ABSTRACT

A program stored in a non-transitory storage medium causes a computer to execute: storing a print job list indicating print schedule for a print job; receiving a change request to change the print schedule; and querying a transmission source of the print job. In the querying the transmission source of the print job, a transmission source of the print job is queried whether or not change of the print schedule according to the change request is acceptable.

### INCORPORATION BY REFERENCE

The present application claims priority under 35 U.S.C. §119 to Japanese Patent Application No. 2016-58269, filed on Mar, 23, 2016. The contents of this application are incorporated herein by reference in their entirety.

### BACKGROUND

The present disclosure relates to a storage medium, an image forming apparatus, and an image forming system.

In recent years, an image forming apparatus is connected to another terminal through wired or wireless communication in many cases for forming an image corresponding to a print job transmitted from the terminal. Once the print job is stored in an external server for the image forming apparatus or a storage section in the image forming apparatus, the server or the storage section generates a print job list indicating print schedule for print jobs including the print job. Then, the image forming apparatus sequentially forms images according to the scheduled order for the print jobs indicated in the print job list.

Typically, the image forming apparatus forms images in order of the print jobs that the server or the storage section stores. However, change of the print schedule may be demanded according to a situation. The image forming apparatus sorts print jobs in accordance with a preset sorting rule and processes by priority a print job that is demanded to be printed urgently.

### SUMMARY

A program stored in a non-transitory storage medium according to the present disclosure causes a computer to execute: storing a print job list indicating print schedule for a print job; receiving a change request to change the print schedule; and querying a transmission source of the print job. In the querying the transmission source of the print job, the transmission source of the print job is queried whether or not change of the print schedule according to the change request is acceptable.

An image forming apparatus according to the present disclosure includes a print job storage section, an image forming section, and a control section. The print job storage section is configured to store therein a print job list indicating print schedule for a print job. The image forming section is configured to form an image in the print schedule. The control section is configured to control the print job storage section and the image forming section. Upon receiving a change request to change the print schedule, the control section queries a transmission source of the print job whether or not change of the print schedule according to the change request is acceptable.

An image forming system according to the present disclosure includes a print job transmitting device, a print job storage device, and an image forming apparatus. The print job transmitting device is configured to transmit a print job. The print job storage section is configured to store therein a print job list indicating print schedule for the print job. The image forming apparatus is configured to form an image in the print schedule. The print job storage device receives a change request to change the print schedule and queries the print job transmitting device whether or not change of the print schedule according to the change request is acceptable.

### BRIEF DESCRIPTION OF THE DRAWINGS

FIG. 1 is schematic illustration of an image forming system according to an embodiment. FIG. 2 is a flowchart depicting processes executed by a storage medium according to the embodiment.

FIG. 3 is a schematic illustration of an image forming system according to another embodiment.

FIG. 4 is a schematic illustration of an image forming system according to still another embodiment.

FIG. 5 is a schematic a print job list in an embodiment.

FIG. 6 is a flowchart depicting processes executed in the image forming system according to an embodiment.

FIG. 7 is a schematic illustration of an image forming apparatus according to an embodiment.

### DETAILED DESCRIPTION

Following describes a storage medium, an image forming apparatus, and an image forming system according to embodiments of the present disclosure with reference to the accompanying drawings. It should be noted that the present disclosure is not limited to the following embodiments.

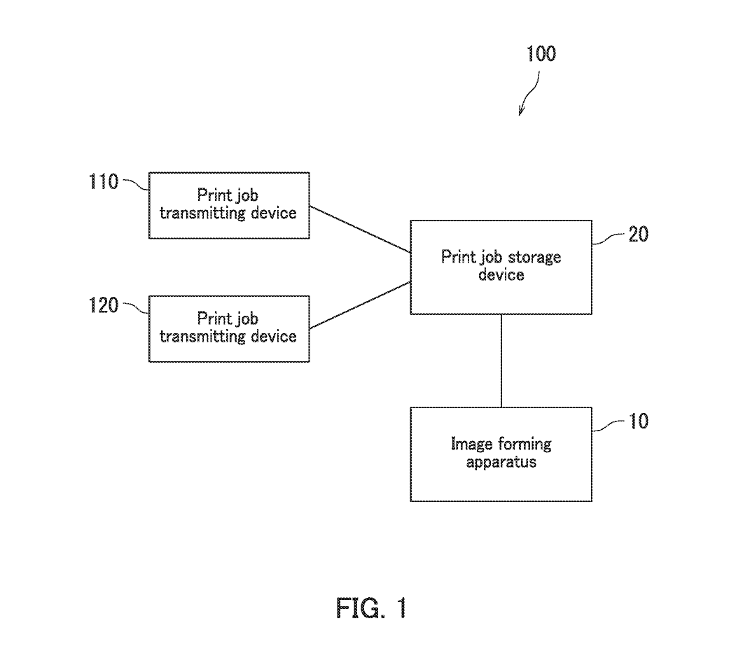

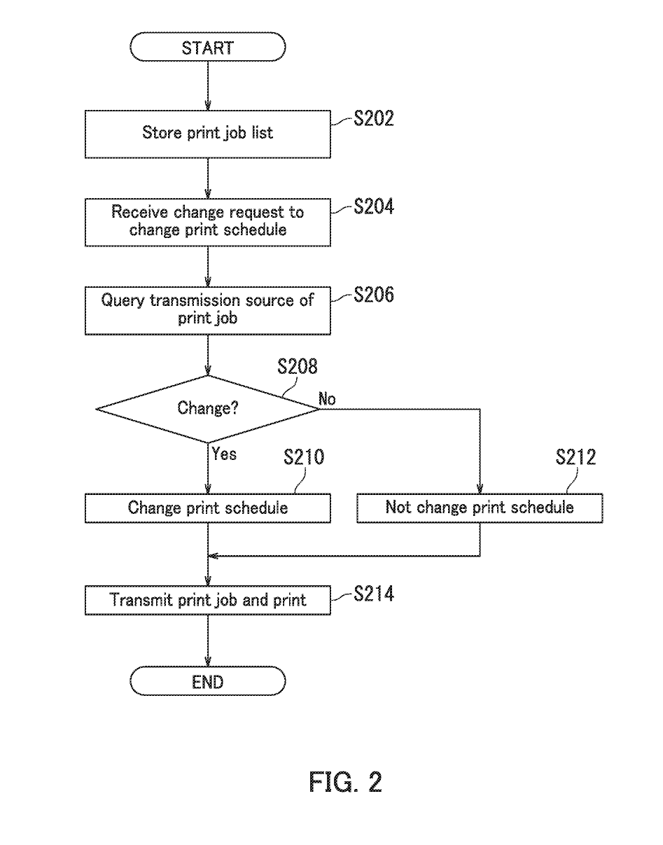

First, an image forming system 100 according to an embodiment will be described with reference to FIG. 1. FIG. 1 is a schematic illustration of the image forming system 100.

The image forming system 100 includes an image forming apparatus 10, a print job storage device 20, a print job transmitting device 110, and a print job transmitting device 120. The image forming apparatus 10 and the print job transmitting devices 110 and 120 are connected to the print job storage device 20 through wired or wireless communication. The print job storage device 20 may be referred simply to a “storage device 20” in the following description. Also, the print job transmitting device 110 and the print job transmitting device 120 may be referred simply to a “transmitting device 110” and a “transmitting device 120”, respectively.

The image forming apparatus 10 performs printing by forming an image on a to-be-printed object. The image forming apparatus 10 may be a printer, for example. Alternatively, the image forming apparatus 10 may be a copier, a facsimile machine, or a multifunction peripheral having functions of a copier and a facsimile machine. The to-be-printed object may be for example a sheet of paper but is not limited to the paper.

The print job storage device 20 stores therein a print job list together with a print job. The storage device 20 may be a server, for example. The storage device 20 stores the print job that is transmitted from either the respective print job transmitting devices 110 or 120. The print job list lists the print job according to print schedule (priority order). Typically, a plurality of print jobs are sequentially listed according to the print schedule in the print job list.

The storage device 20 sequentially transmits the print jobs according to the print schedule indicated in the print job list to the image forming apparatus 10. The image forming apparatus 10 sequentially forms images corresponding to the respective print jobs received from the storage device 20. In principle, print priority of the print jobs is determined according to the order of receipt in the storage device 20. For example, upon receiving a new print job transmitted from the transmitting device 110 or 120, the storage device 20 stores the new print job and add the new print job to the last line of the print job list. For example, a print job that the storage device 20 previously receives has high priority and the image forming apparatus 10 accordingly forms an image corresponding to the previously received print job by priority. By contrast, a print job that the storage device 20 subsequently receives has low priority and the image forming apparatus 10 accordingly forms an image corresponding to the subsequently received print job later.

The print job storage device 20 stores therein a transmission source of a print job together with the print job. For example, the transmission source of a print job stored in the storage device 20 is specified by reference to a device that transmits the print job. In an example, the storage device 20 stores therein an IP address of a device that transmits a print job as a transmission source of the print job. The transmission source of a print job may or may not be indicated in the print job list.

Typically, the storage device 20 operates in accordance with a computer program stored in a storage element provided in the storage device 20. For example, the computer program is stored in a non-transitory computer readable storage medium. Examples of non-transitory computer readable storage media that can be used include a read only memory (ROM), a random access memory (RAM), a CD-ROM (compact disc read-only memory), a magnetic tape, a magnetic disc, and an optical data storage device.

The print job transmitting device 110 transmits a print job toward the image forming apparatus 10. The print job finally reaches the image forming apparatus 10, and the image forming apparatus 10 forms an image corresponding to the print job. When the print job transmitting device 110 transmits a print job toward the image forming apparatus 10, the storage device 20 receives the print job from the transmitting device 110 and temporarily stores the print job. In doing so, the storage device 20 adds the print job to the print job list while storing the print job. Typically, the storage device 20 adds the print job transmitted from the print job transmitting device110 as a print job scheduled to be printed the last among print jobs listed in the print job list. Thereafter, the storage device 20 transmits the print job to the image forming apparatus 10. Once the image forming apparatus 10 forms an image corresponding to the print job, the storage device 20 deletes the print job stored therein and deletes the print job from the print job list.

The print job transmitting device 110 is capable of causing the storage device 20 to change the print schedule indicated in the print job list in the storage device 20. When the print schedule is changed, the storage device 20 transmits the print jobs to the image forming apparatus 10 in the changed print schedule and the image forming apparatus 10 forms images in the changed print schedule.

Similarly, the print job transmitting device 120 transmits a print job toward the image forming apparatus 10. The print job finally reaches the image forming apparatus 10, and the image forming apparatus 10 forms an image corresponding to the print job. When the print job transmitting device 120 transmits a print job toward the image forming apparatus 10, the storage device 20 receives the print job from the transmitting device 120 and temporarily stores the print job. In doing so, the storage device 20 adds the print job to the print job list while storing the print job. Typically, the storage device 20 adds the print job transmitted from the print job transmitting device 120 as a print job scheduled to be printed the last among the print jobs listed in the print job list. Thereafter, the storage device 20 transmits the print job to the image forming apparatus 10. Once the image forming apparatus 10 forms an image corresponding to the print job, the storage device 20 deletes the print job stored therein and deletes the print job from the print job list.

The print job transmitting device 120 is capable of causing the storage device 20 to change the print schedule indicated in the print job list in the storage device 20. When the print schedule is changed, the storage device 20 transmits the print jobs to the image forming apparatus 10 in the changed print schedule and the image forming apparatus 10 forms images in the changed print schedule.

Following describes with reference to FIGS. 1 and 2 processes executed by running a program stored in the storage medium according to the present embodiment. FIG. 2 is a flowchart depicting processes executed by running the program stored in the storage medium in the present embodiment. The processes depicted FIG. 2 may be executed by the storage device 20 reading a computer program stored therein.

As depicted at S202, the storage device 20 stores a print job list indicating print schedule of print jobs. For example, upon receiving a print job transmitted from the transmitting device 110 or 120, the storage device 20 stores the print job and adds the print job to the print job list.

As depicted at S204, the storage device 20 receives a change request to change the print schedule. The change request may be a request for a print start, a print pause, a print resumption, a print cancel, an order change, or a combination of any of them. For example, the transmitting device 110 or 120 transmits to the storage device 20 a change request to change the print schedule indicated in the print job list in the storage device 20 and the storage device 20 receives the change request.

As depicted at S206, the storage device 20 queries the transmission source of a print job whether or not change of the print schedule according to the change request is acceptable for the print job. For example, in a situation in which a plurality of print jobs are listed in the print job list, the storage device 20 queries the transmission source of a print job for which the print schedule is to be changed according to the change request out of the listed print jobs.

As depicted at S208, the storage device 20 determines based on a query reply from the transmission source of the print job whether or not the print schedule indicated in the print job list is to be changed according to the change request. When it is determined that the print schedule in the print job list is to be changed according to the change request (Yes at S208), the storage device 20 changes the print schedule, as depicted at S210. Thereafter, as depicted at S214, the storage device 20 sequentially transmits the print jobs in the changed print schedule to the image forming apparatus 10. The image forming apparatus 10 sequentially forms images corresponding to the respective print jobs in the changed print schedule.

By contrast, when it is determined that the print schedule in the print job list is not to be changed according to the change request (No at S208), the storage device 20 maintains the print job list without changing the print schedule, as depicted at S212. Thereafter, as depicted at S214, the storage device 20 sequentially transmits the print jobs to the image forming apparatus 10 in the print schedule and the image forming apparatus 10 sequentially forms images corresponding to the respective print jobs in the print schedule.

In the above configuration of the image forming system 100 in the present embodiment, the storage device 20 that has received a change request to change the print schedule queries the transmission source of the print job whether or not change of the print schedule according to the change request is acceptable, rather than directly changing the print schedule. The storage device 20 changes the print schedule based on a query reply from the transmission source of the print job. In the image forming system 100 according to the present embodiment, the print schedule is changed according to the change request and based on the reply from the transmission source of the print job. In the above configuration, the image forming apparatus 10 can form an image in appropriate order according to a situation. In the image forming system 100 according to the present embodiment, the print schedule is changed after a query reply. In the above configuration, a situation in which a print job scheduled in the print schedule is abruptly postponed can be prevented. As such, the print schedule is not changed without permission and a user can use the image forming apparatus 10 according to a user's own situation.

For example, when the storage device 20 receives a reply indicating acceptance of change of the print schedule from the transmission source of the print job, the storage device 20 changes the print schedule according to the change request and changes the print job list to a new print job list in which the print schedule is changed. For example, in a situation in which a change request is a request to change the order of print jobs in the print schedule, the storage device 20 changes the order of the print jobs in the print schedule based on the change request. In the above situation, the storage device 20 sequentially transmits the print jobs to the image forming apparatus 10 in the changed print schedule and the image forming apparatus 10 sequentially forms images in the changed print schedule.

Alternatively, for example, when the storage device 20 receives a reply indicating non-acceptance of or inhibition about change of the print schedule from the transmission source of the print job, the storage device 20 does not change the print schedule. In the above situation, the storage device 20 sequentially transmits print jobs to the image forming apparatus 10 in the originally print schedule and the image forming apparatus 10 sequentially forms images in the originally print schedule. In the above situation, the storage device 20 preferably notifies the transmission source of the change request that the change request is not accepted.

The transmission source of the print job may transmit to the storage device 20 notification about non-acceptance of change of the print schedule in advance prior to a query from the storage device 20. In the above configuration, the storage device 20 does not query the transmission source of the print job even upon receiving a change request.

Alternatively, the transmission source of the print job may automatically reply to the query from the storage device 20. For example, the transmission source of the print job may be preset so as to reply that change of the print schedule is or is not accepted in response to a query from the storage device 20. Alternatively, upon receiving a query from the storage device 20, the transmission source of the print job may wait for an instruction from a user who instructs transmission of the print job, and transmit a query reply the based on the users' instruction.

The transmission source of the print job may not reply to a query from the storage device 20. For example, a user who transmits a print job may be absent from a transmission source of the print job. Alternatively, the device of the transmission source of the print job may not be powered on. In a situation in which the storage device 20 receives no query reply from the transmission source of the print job, as in the above situations, the storage device 20 may change the print schedule in accordance with a preset setting.

For example, in a configuration in which the image forming system 100 is capable of flexibly changing the print schedule according to a situation, the storage device 20 may change the print schedule unless a reply including explicit indication as to change of the print schedule is received from the transmission source of the print job within a predetermined time period. Alternatively, in a configuration in which the image forming system 100 follows an intent of a user who transmits a print job, the storage device 20 may maintain the print job list without changing the scheduled print unless a reply including explicit indication as to change of the print schedule is received from the transmission source of the print job within a predetermined time period.

FIG. 1 is referred to herein again. The transmitting device 110 preferably includes a communication section, an input section, and a display section. For example, the communication section includes a communication device (examples include a LAN controller and a PLC modem) that utilizes any of various types of wireless communication (example include a wireless LAN and a Bluetooth) and optical (infrared or visible light) communication. The input section includes a keyboard and/or mouth. The display section includes a display. A touch panel functioning as the input section may be mounted on the top of the display section. For example, the print job transmitting device 110 is implemented by installing a driver for the image forming apparatus 10 on a personal computer. The print job transmitting device 120 preferably includes a communication section, an input section, and a display section likewise the print job transmitting device 110.

Following describes an example of specific operation of the image forming system 100 according to the present embodiment. It is supposed herein that a user A is to cause formation of an image corresponding to a print job A through the transmitting device 110 and a user B is to cause formation of an image corresponding to a print job B through the transmitting device 120.

First, the user A transmits the print job A using the transmitting device 110. The user A may be any user who uses the transmitting device 110. Alternatively, the user A may be a specific user authenticated by the transmitting device 110.

When the user A transmits the print job A using the transmitting device 110, the storage device 20 receives the print job A. The storage device 20 stores the print job A therein and adds the print job A to the print job list.

It is supposed herein that the user B transmits the print job B using the transmitting device 120 after the storage device 20 stores the print job A. The user B may be any user who uses the transmitting device 120. Alternatively, the user B may be a specific user authenticated by the transmitting device 120.

It is supposed herein that the user B desires immediate formation of an image corresponding to the print job B. In the above situation, the user B transmits a change request to change the print schedule to the storage device 20 using the transmitting device 120 so as to advance the print job B and postpone the print job A. For example, the user B transmits the change request to change the print schedule for the print jobs A and B simultaneously with or after transmission of the print job B.

Preferably, the user B is accessible to the print job list prior to transmission of the change request from the transmitting device 120 to the storage device 20. For example, the transmitting device 120 preferably acquires the print job list from the storage device 20 in accordance with an instruction from the user B and displays the acquired print job list.

For example, the user B is enabled to check the print job list through the following. The transmitting device 120 requests the storage device 20 to transmit the print job list. In response to the request for transmission of the print job list from the transmitting device 120, the storage device 20 transmits the print job list to the transmitting device 120. The transmitting device 120 then displays the received print job list. Through the above, the user B is enabled to check the print job list.

For example, the change request from the transmitting device 120 may be a request to advance the print job B from all print jobs listed in the print job list. In the above situation, when the storage device 20 receives the change request from the transmitting device 120, the storage device 20 checks whether or not there are any print jobs having priority higher than the print job B in the print job list. Alternatively, the change request from the transmitting device 120 may be a request to designate the print job B to be advanced from a specific print job (the print job A herein) in the print job list.

The storage device 20 that has received the change request from the transmitting device 120 may check whether or not there are any print jobs having priority higher than the print job B in the print job list. In a situation in which there is a print job having priority higher than the print job B in the print job list, the storage device 20 queries the transmission source of the print job having higher priority than the print job B whether or not change of the print schedule is acceptable. In the situation herein, there is the print job A having priority higher than the print job B. Accordingly, the storage device 20 queries the transmitting device 110 that is the transmission source of the print job A whether or not change of the print schedule is acceptable.

Once receiving the query, the transmitting device 110 notifies of the content of the query the user A of the transmitting device 110. For example, the transmitting device 110 displays the content of the query from the storage device 20.

When the user A replies to the query that change of the print schedule is acceptable using the transmitting device 110, the storage device 20 changes the print schedule according to the change request and changes the print job list to a new print job list in which the print job B is advanced and the print job A is postponed. In the above configuration, the storage device 20 sequentially transmits the print job B and A in this order to the image forming apparatus 10 and the image forming apparatus 10 sequentially forms images corresponding to the print jobs B and A in this order.

By contrast, when the user A replies to the query using the transmitting device 110 that change of the print schedule is not acceptable, the storage device 20 maintains the original print job list without changing the print schedule against the change request. In the above configuration, the storage device 20 sequentially transmits the print job A and B in this order to the image forming apparatus 10 and the image forming apparatus 10 sequentially forms images corresponding to the print jobs A and B in this order.

In the above description, the transmitting device 120 transmits a change request to change the print schedule for a print job transmitted from the transmitting device 110, which however should not be taken to limit the present embodiment. The transmitting device 120 may transmit a change request to change the print schedule for a print job previously transmitted from the transmitting device 120 itself. In a situation in which a device that has transmitted a print job and a device that has transmitted a change request are the same as above, the storage device 20 may change the print schedule without querying the device that has transmitted the print job.

Further, in a configuration in which the transmitting devices transmit a user's name together with either or both a print job and a change request, the storage device 20 may change the print schedule without querying a user who transmits a print job when the user's name transmitted together with the print job is the same as that transmitted together with a change request. Alternatively, the storage device 20 may make a query even in a situation in which one of a user's name and a transmission source is the same between a print job and a change request, in the situation in which the other is different likewise.

A print job may be capable of being designated an urgent job as necessary. In a situation in which a print job is designated an urgent job, the storage device 20 that has received a change request does not regard the urgent job as a change target and query a transmission source of the urgent job.

For example, a print job may be designated an urgent job when the transmitting device 110 or 120 transmits the print job. Alternatively, a print job after being transmitted from a transmitting device 110 or 120 may be designated an urgent job lately through the transmitting device 110 or 120.

The storage device 20 may store status of a print job. For example, the status of a print job may be determined as any one of a printed state, a waiting state, a pausing state, and a canceled state.

For example, during the time when the storage device 20 transmits a print job to the image forming apparatus 10 and the image forming apparatus 10 forms an image corresponding to the print job, the print job is in the printed state. During the time when the storage device 20 has not yet transmitted a print job to the image forming apparatus 10, the print job is in the waiting state. During the time when the storage device 20 has transmitted a print job to the image forming apparatus 10 and the image forming apparatus 10 pauses to form an image corresponding to the print job, the print job is in the pausing state. During the time when the storage device 20 has transmitted a print job to the image forming apparatus 10 but the print instruction is canceled before the image forming apparatus 10 starts forming an image corresponding to the print job, the print job is in the canceled state. The status of a print job may be or may not be indicated in the print job list.

For example, in a situation in which a print job is in the printed state, the storage device 20 that has received a change request may not regard the print job in the printed state as a change target print job and query a transmission source of the print job. By contrast, in a situation in which a print job is in any one of the waiting state, the pausing state, and the canceled state, the storage device 20 that has received a change request preferably queries the transmission source of the print job.

The storage device 20 preferably stores therein a processing period necessary for each print job. In the above configuration, the processing periods necessary for the respective print jobs are preferably indicated in the print job list. The storage device 20 receives a new print job transmitted from the transmitting device 110 or 120 and adds the new print job to the print job list. In doing so, the storage device 20 preferably calculates a processing period necessary for the new print job, for example.

The storage device 20 updates the print job list each time a print job is received. In the above configuration, the storage device 20 preferably calculates a processing period necessary for each print job listed in the updated print job list. In calculation of a processing period necessary for a print job, the processing period is preferably calculated based on the number of pages in the print job, for example.

For example, the print job transmitting devices 110 and 120 are each implemented by installing a driver for the image forming apparatus 10 on a personal computer. In installation of the driver, preferably, a print job manager is preferably installed on the personal computer together with the driver. For example, the print job manager periodically accesses the storage device 20, and acquires the print job list from the storage device 20, and appropriately updates and acquires information on the print job list. Alternatively, the storage device 20 may access the print job manager in the transmitting devices 110 and 120 in the event of change of the print job list and transmit a new print job list. Further, the print job list and change of the print schedule are preferably checked using the print job manager. The print job manager facilitates display of the print job list stored in the storage device 20 in the transmitting devices 110 and 120.

The image forming system 100 includes two print job transmitting devices (i.e., the print job transmitting devices 110 and 120) in the above description with reference to FIG. 1, which however should not be taken to limit the present embodiment. The image forming system 100 may include three or more print job transmitting devices. Alternatively, the image forming system 100 may include only one print job transmitting device.

Either of the transmitting devices 110 and 120 in the above description with reference to FIG. 1 transmits a change request to the storage device 20 storing a print job that the transmitting device 110 or 120 has transmitted. However, the transmitting devices 110 and 120 may transmit a change request to the storage device 20 storing a print job that the transmitting devices 110 and 120 have not transmitted.

The transmitting devices 110 and 120 cause change of the print schedule in the above description with reference to FIG. 1, which however should not be taken to limit the present embodiment. The image forming apparatus 10 may cause change of the print schedule.

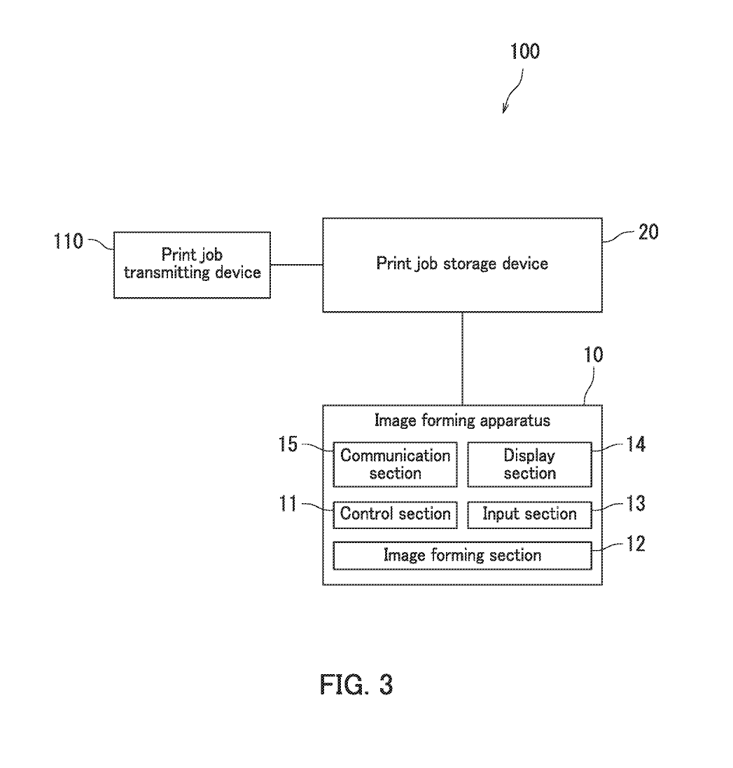

An image forming system 100 according to another embodiment will be described below with reference to FIG. 3. The image forming system 100 in the present embodiment has a configuration similar to that of the image forming system 100 described with reference to FIG. 1 in all aspects other than that only one print job transmitting device 110 is included and an image forming apparatus 10 changes the print schedule. Description of matter that is similar to that for the configuration of the image forming system 100 described with reference to FIG. 1 is omitted for avoiding redundancy.

The image forming system 100 includes the image forming apparatus 10, a print job storage device 20, and the print job transmitting device 110. The image forming apparatus 10 includes a control section 11, an image forming section 12, an input section 13, a display section 14, and a communication section 15.

The control section 11 controls the image forming section 12, the input section 13, the display section 14, and the communication section 15. The control section 11 includes a general-purpose computer or a dedicated device including a control processing unit (CPU), for example.

The image forming section 12 forms an image on a to-be-printed object. A user inputs an instruction to the image forming apparatus 10 using the input section 13. The input section 13 includes buttons and/or a keyboard, for example. The display section 14 includes a display. A touch panel functioning as the input section 13 may be mounted on the top of the display section 14, for example. The communication section 15 communicates with the storage device 20. As will be described later in detail, the communication section 15 transmits to the storage device 20 a change request to change print schedule.

The storage device 20 stores therein a print job list indicating the print schedule for print jobs. For example, upon receipt of a print job transmitted from the transmitting device 110, the storage device 20 stores the print job and adds the print job to the print job list.

A user transmits a change request to change the print schedule to the storage device 20 using the image forming apparatus 10. For example, when the user inputs a change request to the input section 13 of the image forming apparatus 10, the communication section 15 transmits the change request to the storage device 20.

Preferably, the user inputs a change request using the input section 13 of the image forming apparatus 10 after checking the print job list displayed on the display section 14 and then the communication section 15 transmits the change request to the storage device 20. In order to cause the display section 14 of the image forming apparatus 10 to display the print job list, preferably the user requests acquisition of the print job list using the input section 13 and then the communication section 15 transmits an acquisition request to acquire the print job list to the storage device 20 for acquiring the print job list from the storage device 20.

Upon receiving the change request from the image forming apparatus 10, the storage device 20 queries the transmitting device 110 that is the transmission source of a print job whether or not change of the print schedule for the print job is acceptable. The storage device 20 determines based on a query reply from the transmitting device 110 whether or not the print schedule is to be changed according to the change request.

When it is determined that the print schedule is to be changed according to the change request, the storage device 20 changes the print schedule. By contrast, when it is determined that the print schedule is not to be change according to the change request, the storage device 20 maintains the print job list without changing the print schedule. In the above configuration, preferably the storage device 20 replies to the communication section 15 of the image forming apparatus 10 that the print schedule is not changed and the display section 14 displays information indicating that the change request is not accepted.

The storage device 20 stores a print job transmitted from the transmitting device 110 and adds the print job to the print job list in the description with reference to FIG. 3, which however should not be taken to limit the present embodiment. The storage device 20 may store a print job transmitted from the image forming apparatus 10 and adds the print job to the print job list. For example, in a configuration in which the image forming apparatus 10 includes a storage element having a comparatively small capacity and a reading section that reads an image of an original document, the image forming apparatus 10 may transmit a read image as a print job to the storage device 20 through the communication section 15 and the storage device 20 may store the print job.

In the above description, the storage device 20 that stores a print job from a single transmitting device as a transmission source and queries upon receiving a change request, the single transmitting device as the transmission source in order to avoid complicated description. However, the present embodiment is not limited to the above configuration. The storage device 20 may store a plurality of print jobs from a plurality of transmitting devices as transmission sources and query upon receiving a change request, plural transmitting devices as transmission sources of print jobs that are change targets among the plurality of transmitting devices.

The storage device 20 that stores print jobs and the print job list is located in the exterior of the image forming apparatus 10 in the above description with reference to FIGS. 1 and 3, which however should not be taken to limit the above embodiments. The storage device 20 may be located in the interior of the image forming apparatus 10 to constitute a part of the image forming apparatus 10.

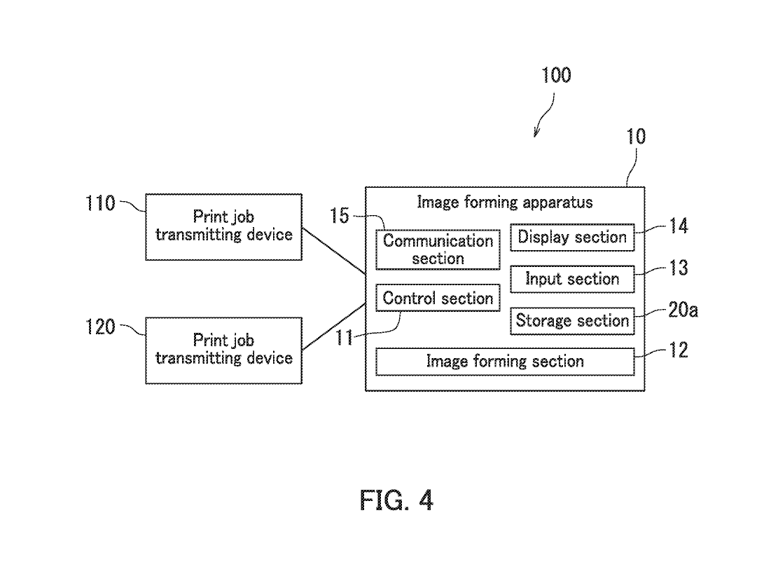

An image forming system 100 according to still another embodiment will be described below with reference to FIG. 4. The image forming system 100 has a configuration similar to that of the image forming system 100 described with reference to FIG. 1 in all aspect other than that the image forming system 100 includes no storage device 20 and the image forming apparatus 10 includes a print job storage section 20a. Description of matter that is similar to that for the configuration of the image forming system 100 described with reference to FIG. 1 is omitted for avoiding redundancy.

The image forming system 100 includes the image forming apparatus 10, a print job transmitting device 110, and a print job transmitting device 120. The image forming apparatus 10 includes a control section 11, an image forming section 12, an input section 13, a display section 14, a communication section 15, and the storage section 20a.

The control section 11 controls the image forming section 12, the input section 13, the display section 14, and the communication section 15. The image forming section 12 forms an image on a to-be-printed object. A user inputs an instruction to the image forming apparatus 10 through the input section 13. The input section 13 includes buttons and/or a keyboard, for example. The display section 14 includes a display. A touch panel functioning as the input section 13 may be mounted on the top of the display section 14, for example. The communication section 15 communicates with the transmitting devices 110 and 120.

The storage section 20a may store a computer program for controlling the image forming apparatus 10 (mainly, the control section 11). The storage section 20a includes a hard disk, a ROM, or a RAM, for example. The ROM may be a programmable ROM (PROM) such as a flash memory, for example. The RAM may be a dynamic RAM (DRAM), for example.

For example, the computer program is stored in a non-transitory computer readable storage medium. Examples of non-transitory computer readable storage media that can be used include a ROM, a RAM, a CD-ROM, a magnetic tape, a magnetic disc, and an optical data storage device.

The storage section 20a stores therein a print job list indicating print schedule for print jobs. For example, upon receiving a print job transmitted from the transmitting device 110 or 120, the storage section 20a stores the print job and adds the received print job to the print job list.

The control section 11 of the image forming apparatus 10 receives a change request to change the print schedule. For example, the control section 11 receives a change request from any of the transmitting devices 110 and 120 and the input section 13 of the image forming apparatus 10. The change request may be a request for a print start, a print pause, a print resumption, a print cancel, an order change, or a combination of any of them.

The image forming apparatus 10 queries the transmission source of a print job whether or not change of the print schedule according to the change request is acceptable for the print job. For example, the communication section 15 queries the transmitting devices 110 and 120 whether or not change of the print schedule according to the change request may be acceptable for a print job that the transmitting device 110 or 120 transmits.

The communication section 15 receives a query reply from the transmitting device 110 or 120. The control section 11 determines based on the query reply from the transmitting devices 110 or 120 whether or not the print schedule in the print job list is to be changed according to the change request. When it is determined that the print schedule in the print job list is to be changed according to the change request, the control section 11 generates a new print job list in which the print schedule is changed and the storage section 20a stores the new print job list. By contrast, when it is determined that the print schedule in the print job list is not to be changed according to the change request, the storage section 20a maintains the print job list without changing the print schedule.

The transmission source of a print job stored in the storage device 20 is specified by reference to a device that transmits the print job in the description with reference to FIGS. 1-4, which however should not be taken to limit the above embodiments. The transmission source of a print job stored in the storage device 20 may be specified by reference to a user who has transmitted the print job. For example, the storage device 20 may store therein a user's address (for example, an address of a user's mobile terminal) as a transmission source of a print job.

Further, the print jobs and the print job list are stored in the same storage element (the storage device 20 or the storage section 20a) in the above description with reference to FIGS. 1-4, which however should not be taken to limit the above embodiments. The print jobs and the print job list may be stored in different storage elements.

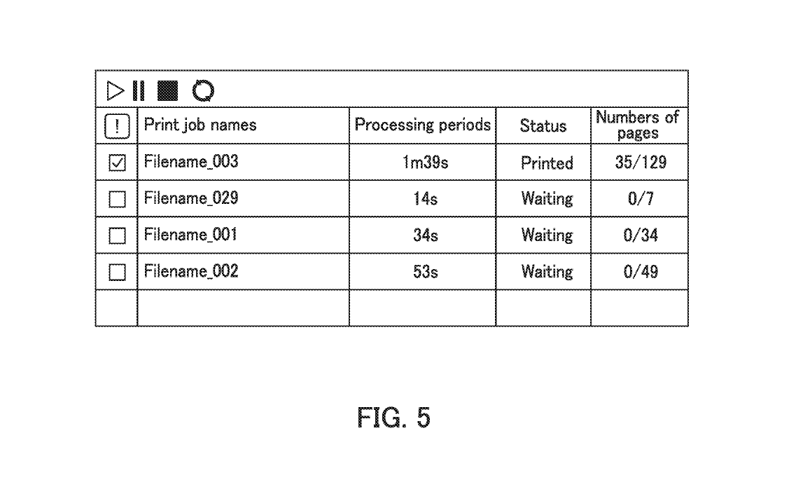

With reference to FIG. 5, an example of the print job list in an embodiment will be described below. FIG. 5 is a print job list in the present embodiment.

The print job list in FIG. 5 lists respective names of a plurality of print jobs in print schedule. Here, a print job scheduled to be printed first has a name “Filename 003”. A print job scheduled to be printed second has a name “Filename_029”. A print job scheduled to be printed third has a name “Filename_001”. A print job scheduled to be printed fourth has a name “Filename_002”.

Whether or not the print jobs are each an urgent job is indicated in a column located left of the column of print job names A box in the left column corresponding to “Filename_003” is checked to indicate that the print job “Filename_003” is an urgent job. By contrast, respective boxes in the left column corresponding to “Filename_029”, “Filename_001”, and “Filename_002” are not checked and accordingly, each of the print jobs “Filename_029”, “Filename_001”, and “Filename_002” is not an urgent job.

Processing periods of the respective print jobs are indicted in a column located directly right of the column of print job names. Here, the processing period necessary for the print job “Filename_003” is 1 minute and 39 seconds. The processing period necessary for the print job “Filename_029” is 14 seconds. The processing period necessary for the print job “Filename_001” is 34 seconds. The processing period necessary for the print job “Filename_002” is 53 seconds.

The status of the respective print jobs is indicted in a column located directly right of the column of processing periods. Here, the print job “Filename_003” is in the printed state while the print jobs “Filename_029”, “Filename_001”, and “Filename_002” are in the waiting state.

The total numbers of pages and the numbers of processed pages are indicated in a column located directly right of the column of status. Here, the total number of pages and the number of processed pages in the print job “Filename_003” are 129 pages and 35 pages, respectively. The total number of pages and the number of processed pages in the print job “Filename_029” are 7 pages and 0 pages, respectively. The total number of pages and the number of processed pages in the print job “Filename_001” are 34 pages and 0 pages, respectively. The total number of pages and the number of processed pages in the print job “Filename_002” are 49 pages and 0 pages, respectively.

Note that the items, layout, displaying manner, etc. of the print job list indicated in FIG. 5 are mere examples for easy understanding of the present embodiment. It is needless to say that the items, layout, displaying manner, etc. of the print job list can be altered according to use.

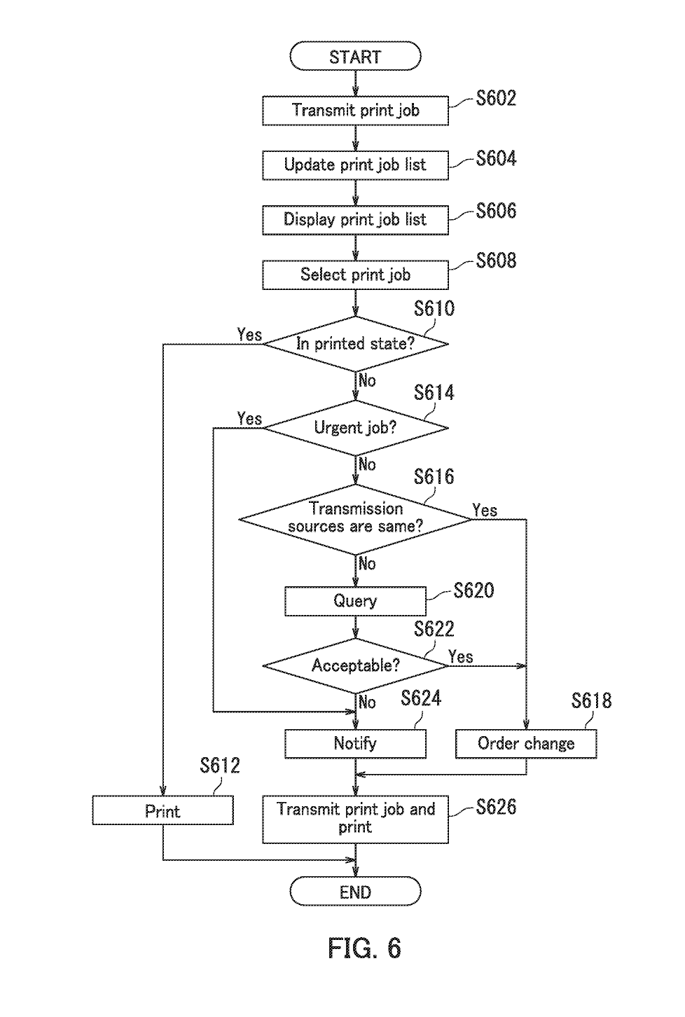

Processes performed in the image forming system 100 in FIG. 1 according to the present embodiment will be described below with reference to FIG. 6. FIG. 6 is a flowchart depicting the processes that the image forming system 100 according to the present embodiment performs.

As described above, the storage device 20 may read a computer program stored therein to execute a part of the processes depicted with reference to FIG. 6. Further, as described with reference to FIG. 4, the image forming apparatus 10 may include the storage section 20a in place of the storage device 20 located in the exterior of the image forming apparatus 10. It is supposed herein that the print job list lists a print job 1 and a user B desires change of the print schedule for a print job 2 through the transmitting device 120.

As depicted at S602, the user B transmits the print job 2 using the transmitting device 120. The storage device 20 already stores the print job 1, and the print job list already lists the print job 1.

As depicted at S604, upon receiving the print job 2, the storage device 20 updates the print job list in a manner to add the print job 2 to the print job list in addition to the print job 1. In the current print job list, the print job 1 has high priority and the print job 2 has low priority.

As depicted at S606, the user B causes the transmitting device 120 to display the print job list. The user B requests using the transmitting device 120, the storage device 20 to transmit the print job list. The storage device 20 transmits the print job list to the transmitting device 120 in response. As a result, the transmitting device 120 displays the print job list.

As depicted at S608, the user B selects the print job 1 as a change target from the print job list displayed on the transmitting device 120. Then, the user B transmits using the transmitting device 120, a change request to change the print schedule so that the print job 1 is executed after the print job 2.

As depicted at S610, upon receiving the change request from the transmitting device 120, the storage device 20 determines whether or not the print job 1 that is a change target is in the printed state. When it is determined that the print job 1 is in the printed state (Yes at S610), the storage device 20 directly transmits the print job 1 to the image forming apparatus 10 by priority and the image forming apparatus 10 forms an image corresponding to the print job 1 by priority, as depicted at S612. The storage device 20 then transmits the print job 2 to the image forming apparatus 10 and the image forming apparatus 10 forms an image corresponding to the print job 2.

When it is determined that the print job 1 is not in the printed state (No at S610), that is, the print job is in the pausing state, the waiting state, or the canceled state, the storage device 20 determines whether or not the print job 1 that is a change target is an urgent job, as depicted at S614. When it is determined that the print job 1 is an urgent job (Yes at S614), the storage device 20 notifies the transmitting device 120 that is the transmission source of the change request that the print job 1 is an urgent job and the print schedule cannot be changed, as depicted at 624. Further, as depicted at S626, the storage device 20 transmits the print job 1 to the image forming apparatus 10 by priority and the image forming apparatus 10 forms an image corresponding to the print job 1 by priority. Thereafter, the storage device 20 transmits the print job 2 to the image forming apparatus 10 and the image forming apparatus 10 forms an image corresponding to the print job 2.

When it is determined that the print job 1 is not an urgent job (No at S614), the storage device 20 determines whether or not the transmission source of the print job 1 is the same as the transmission source of the change request. When it is determined that the transmission source of the print job 1 is the same as the transmission source of the change request (Yes at S616), the storage device 20 changes the print schedule according to the change request and updates the print job list, as depicted at S618. Thereafter, as depicted at S626, the storage device 20 transmits the print job 2 to the image forming apparatus 10 by priority according to the updated print schedule and the image forming apparatus 10 forms an image corresponding to the print job 2 by priority. Subsequently, the storage device 20 transmits the print job 1 to the image forming apparatus 10 and the image forming apparatus 10 forms an image corresponding to the print job 1.

When it is determined that the transmission source of the print job 1 is different from the transmission source of the change request (No at S616), the storage device 20 queries the transmission source of the print job 1 whether or not change of the print schedule according to the change request is acceptable, as depicted at S620. Thereafter, as depicted at S622, the storage device 20 determines whether or not a query reply from the transmitting device 110 indicates acceptance.

If the query reply from the transmitting device 110 indicates acceptance (Yes at S622), the storage device 20 changes the print schedule and updates the print job list, as depicted at S618. Thereafter, as depicted at S626, the storage device 20 transmits the print job 2 to the image forming apparatus 10 by priority according to the changed print schedule and the image forming apparatus 10 forms an image corresponding to the print job 2 by priority. Thereafter, the storage device 20 transmits the print job 1 to the image forming apparatus 10 and the image forming apparatus 10 forms an image corresponding to the print job 1.

If the storage device 20 does not receive from the transmitting device 110 a query reply indicating acceptance (No at S622), in other words, if a query reply indicating non-acceptance is transmitted or no reply is transmitted from the transmitting device 110, the storage device 20 notifies the transmitting device 120 that the change request is not accepted, as depicted at S624. Further, as depicted at S626, the storage device 20 directly transmits the print job 1 to the image forming apparatus 10 by priority and the image forming apparatus 10 forms an image corresponding to the print job 1 by priority. Thereafter, the storage device 20 transmits the print job 2 to the image forming apparatus 10 and the image forming apparatus10 forms an image corresponding to the print job 2.

In the configuration as above in the present embodiment, the image forming apparatus 10 can be smoothly perform image formation based on the status of the print job 1 that is a change target, the set condition of the print job 1, and a query reply from the transmission source of the print job 1 without taxing patience for specific user's.

The change request in the above description with reference to FIG. 6 is a request to change the print schedule so that the print job 2 is advanced from the print job 1, which however should not be taken to limit the present embodiment. The change request may be a request for a print start, a print pause, a print resumption, or print cancel for a print job. Alternatively, the change request may be a request for a combination of any of them.

The aforementioned image forming apparatus 10 preferably has the following configuration. The image forming apparatus 10 will be described below.

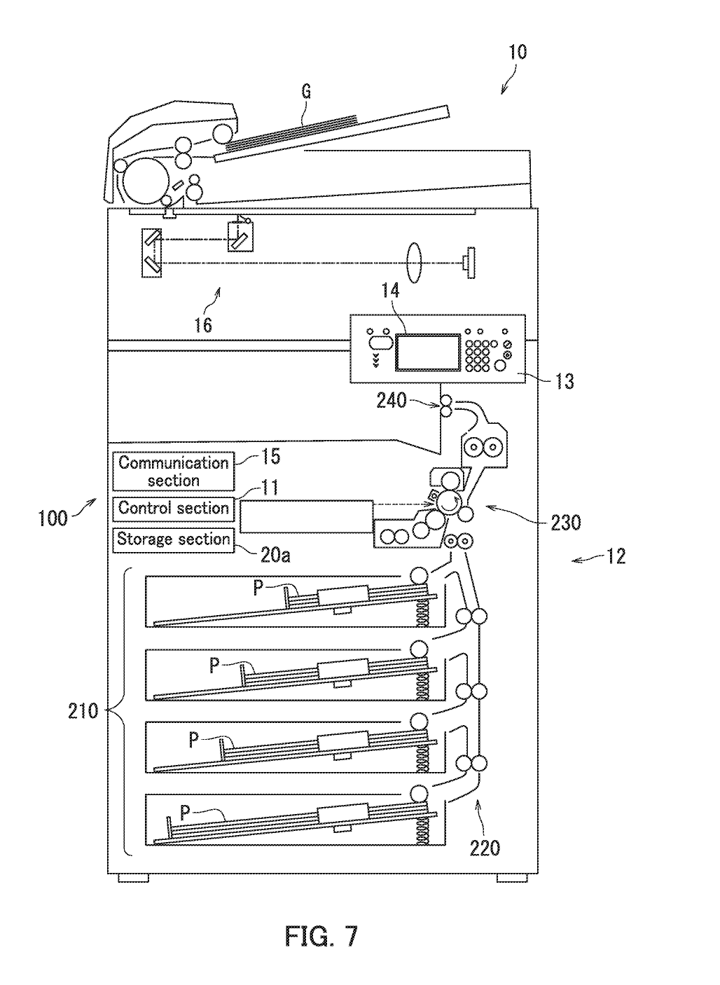

FIG. 7 is a schematic illustration of the image forming apparatus 10 according to an embodiment. The image forming apparatus 10 includes a control section 11, an image forming section 12, an input section 13, a display section 14, a reading section 16, and a storage section 20a. The image forming section 12 includes a feeding section 210, a conveyance section 220, an image forming unit 230, and an ejection section 240.

The control section 11 includes a general-purpose computer or a dedicated device including a central processing unit (CPU), for example. The control section 11 controls operation of the image forming apparatus 10 by running a computer program stored in the storage section 20a. The reading section 16 reads an image of an original document G. The storage section 20a includes a main storage device and an auxiliary storage device. The display section 14 is a display having a touch panel serving as the input section 13. The feeding section 210 accommodates a plurality of to-be-printed objects P and conveys the to-be-printed objects P one at a time to the conveyance section 220. The to-be-printed objects P are sheets of paper or synthetic resin, for example. The conveyance section 220 includes a plurality of conveyance rollers and conveys the to-be-printed object P to the image forming unit 230. The image forming unit 230 forms a toner image on the to-be-printed object P by an electrographic process and applies heat and pressure to the toner image to fix the toner image to the to-be-printed object P. The conveyance section 220 conveys to the ejection section 240, the to-be-printed object P to which the toner image is fixed. The ejection section 240 ejects the to-be-printed object P outside the image forming apparatus 10.

An electrographic image forming apparatus is illustrated in FIG. 7 as an example of the image forming apparatus 10. However, the present embodiment is not limited to the electrographic image forming apparatus. The image forming apparatus 10 may be an image forming apparatus of any type. For example, the image forming apparatus 10 may be an inkjet image forming apparatus.

1. A storage medium non-transitorily storing therein a program that causes a computer to execute:
storing a print job list indicating print schedule for a print job;
receiving a change request to change the print schedule;
querying a transmission source of the print job without changing the print schedule as to whether or not change of the print schedule according to the change request is acceptable;
receiving, from the transmission source, a reply to the query to the transmission source; and
changing the print schedule according to the change request and based on the reply.

2. The storage medium according to claim 1, wherein:
the storing the print job list includes:
receiving a first job from a first device; and
adding the first print job to the print job list,
the receiving the change request includes receiving from a second device a change request to change the print schedule for the first print job, and
the querying the transmission source of the print job includes querying the first device whether or not change of the print schedule according to the change request from the second device is acceptable for the first print job.

3. The storage medium according to claim 2, wherein
in the receiving the change request and the querying the transmission source of the print job, the second device is different from the first device.

4. The storage medium according to claim 1, wherein
in the receiving the change request, the change request includes at least one of requests for a print start, a print pause, a print resumption, a print cancel, an order change.

5. (canceled)

6. The storage medium according to claim 1, wherein the program further causes the computer to execute
calculating a processing period necessary for the print job in the print job list.

7. The storage medium according to claim 6, wherein
in the calculating the processing period, the processing period is calculated based on the number of pages in the print job.

8. The storage medium according to claim 1, wherein
in the querying the transmission source of the print job, in a situation in which the print job is a target of the change request and designated as an urgent print job, a notification indicating that change of the print schedule is not accepted is transmitted to a transmission source of the change request without querying the transmission source of the print job whether or not change of the print schedule according to the change request is acceptable.

9.-10. (canceled)

11. The storage medium according to claim 1, wherein
in the changing the print schedule,
the print schedule is changed according to the change request in a situation in which the reply indicates change of the print schedule according to the change request is acceptable, and
the print schedule is maintained against the change request in a situation in which the reply indicates change of the print schedule according to the change request is not acceptable.

12. The storage medium according to claim 1, wherein the program further causes the computer to execute:
displaying the print job list on a display of the transmission source of the print job.

13. The storage medium according to claim 1, wherein
in the receiving the change request, the change request includes a print job that is to be changed and that is selected from the print job list.

14.-19. (canceled)
